(19) United States
(12) Patent Application Publication
(10) Pub. No.: US 2024/0247872 A1
(43) Pub. Date: Jul. 25, 2024

(54) A WALL FOR A FURNACE, A REFRACTORY BRICK FOR A WALL FOR A FURNACE, A FURNACE, A FASTENING SYSTEM, A METHOD FOR FASTENING A REFRACTORY BRICK IN A GROOVE, AND A METHOD OF MANUFACTURING A WALL FOR A FURNACE

(71) Applicant: REFRACTORY INTELLECTUAL PROPERTY GMBH & CO. KG, Wien (AT)

(72) Inventor: Bojan ZIVANOVIC, Wien (AT)

(21) Appl. No.: 18/566,527

(22) PCT Filed: May 31, 2022
(86) PCT No.: PCT/EP2022/064742

§ 371 Date: Dec. 1, 2023

(30) Foreign Application Priority Data
Jun. 1, 2021 (EP) 21177132.4

(51) Int. Cl. F27D 1/00; F27D 1/14

(52) U.S. Cl. CPC F27D 1/004; F27D 1/141; F27D 1/147; F27D 2001/005

(57) ABSTRACT

The invention relates to a wall for a furnace, a refractory brick for a wall for a furnace, a furnace, a fastening system, a method for fastening a refractory brick in a groove, and a method for manufacturing a wall for a furnace.

The invention relates to a wall for a furnace, a refractory brick for a wall for a furnace, a furnace, a fastening system, a method for fastening a refractory brick in a groove, and a method for manufacturing a wall for a furnace.

Furnaces, especially industrial furnaces, have a combustion chamber in which products can be treated at high temperatures. This firing chamber is regularly enclosed by refractory bricks. The refractory bricks can be fastened to a wall element on their cold side, i.e., their side facing away from the combustion chamber. Such wall elements can in particular be made of metal and have a frame-like enclosure by which the refractory bricks can be held in position on the wall element. Such wall elements are also known in the form of cooling elements through which the refractory bricks are cooled. Such wall elements in the form of cooling elements may have conduits for conducting cooling water, whereby the wall elements may be cooled. A wall system for a furnace comprising a wall element with refractory bricks fastened thereto is known, for example, from EP 3 500 812 B1.

A central aspect of such a wall for a furnace is the secure fastening of the refractory bricks to the wall element. If the refractory bricks become detached during operation of the furnace, components from the combustion chamber, for example hot combustion gases or molten metal, can reach the wall element directly and thus impair the integrity of the wall.

To securely fasten the refractory bricks to the wall element, the prior art regularly uses metallic anchors or metallic rods that extend into or through the refractory bricks to fasten the refractory bricks to the wall element.

Through extensive testing, the inventor of the present application has found that, in particular, such metallic anchors or metallic rods can be a weak point in the attachment of the refractory bricks to the wall element.

Furthermore, attaching refractory bricks to a wall element by means of such metallic anchors or rods is often complicated.

It is an object of the invention to provide a wall for a furnace, which comprises a wall element with refractory bricks fastened thereto, the refractory bricks being securely fastened to the wall element. In particular, the bricks are to be particularly securely and easily attachable to the wall element.

It is a further object of the invention to provide a furnace comprising such a wall.

It is a further object of the invention to provide a method for manufacturing such a wall.

It is a further object of the invention to provide a refractory brick for a wall for a furnace, which is securely and easily attachable to a wall member of the wall.

To solve the above objects, there is first provided a wall for a furnace, comprising
a wall member comprising a surface and a plurality of grooves extending along the surface, spaced apart and parallel to each other;
refractory bricks, each comprising a fastening portion disposed in one of the grooves;
fastening elements each clamped between one of the fastening portions and the groove in which the respective fastening portion is disposed; wherein
the refractory bricks are each non-positively fastened in the groove by clamping at least one of the fastening elements between the fastening portion of the respective refractory brick and the groove in which the respective fastening portion is disposed.

The invention is based in particular on the surprising finding that a refractory brick can be securely and easily fastened to a wall element of a wall for a furnace if the refractory brick is fastened to the wall element by means of a non-positive connection. The fact that a refractory brick can be fastened to a wall element of a furnace by means of such a non-positive connection is all the more surprising against the background of the fact that in the prior art refractory bricks were regularly fastened to a wall element by means of a material-locking connection or a form-fitting connection. Thus, as explained above, refractory bricks have so far been regularly fastened to the wall element either by a form-fit connection via anchors or rods or by a material-fit connection by means of hardening masses, for example refractory concretes.

However, refractory bricks that are non-positively fastened to the wall element have numerous advantages. On the one hand, the refractory bricks can be fastened to the wall element particularly securely and easily. For a non-positive connection, only the frictional connection has to be made, whereby the bricks are immediately fastened force-lockingly in a defined position to the wall element. However, it is also advantageous that a non-positive connection can be released again particularly easily at any time. For this purpose, only a force counteracting the non-positive connection has to be applied, whereby the refractory brick can be released from the wall element again. Such a solution of the non-positive connection may be necessary, for example, in order to change a position of a refractory brick on the wall element or also to detach the refractory brick from the wall element, for example, in order to detach it from the wall element in the event of damage or wear and to replace it with a new refractory brick.

According to the invention, a non-positive connection is generally referred to as a force-locking connection, which is also referred to as a frictional connection.

In order to be able to fasten the refractory bricks to the wall element in a non-positive manner according to the invention, the wall element has a surface and several grooves, the grooves running along the surface of the wall element at a distance from and parallel to one another. Furthermore, the refractory bricks each have a fastening portion that can be arranged in a respective one of the grooves. The non-positive fastening of each refractory brick to the wall element is now brought about in each case by a fastening element being clamped between the fastening portion and the groove in such a way that the refractory brick is in each case non-positively fastened in the groove and thus fastened to the wall element. According to the invention, a fastening element is clamped or pressed between the fastening portion of a refractory brick and the groove, creating a non-positive connection.

Due to this non-positive connection of the refractory bricks to the wall element, there is no need to fasten the refractory bricks to the wall element by means of metallic elements guided through the bricks. Therefore, the wall according to the invention may also be characterized in particular by the fact that it does not comprise metallic elements guided through the refractory bricks. In particular, the wall according to the invention preferably does not comprise metallic rods guided by the refractory bricks.

Preferably, the fastening elements are fastened to the wall exclusively via a non-positive connection between the fastening portion and the groove as described above. In this respect, the fastening elements are preferably not fastened to the wall beyond this, i.e., for example, they are connected to it by a material or form fit, i.e., in particular preferably not welded or screwed to it. This has the particular advantage that the fastening elements can be detached from the wall again at any time solely by a force counteracting the frictional connection. This has in particular the advantage that the position of a refractory brick on the wall element can be very easily changed or variably selected (for example, to select a specific position of the refractory brick with regard to its respective geometry) or the refractory brick can be detached from the wall element (for example, to replace the refractory brick with a new refractory brick).

According to a preferred embodiment, the fastening portions each have a wedge-shaped section, with at least one of the fastening elements being clamped between the wedge-shaped section and the groove in each case. In such an embodiment, the fastening element can be clamped particularly easily between the fastening section of the respective refractory brick and the groove in order to produce a non-positive connection. This is because such a wedge-shaped section allows the fastening portion to be pushed onto the fastening element until a non-positive connection or self-locking is established. The wedge-shaped section of the fastening portion forms a ramp or run-up surface onto which the fastening element can be pushed until a non-positive connection or self-locking is achieved. It is expedient for the wedge-shaped section to widen along the longitudinal extension of the groove. In particular, this has the advantage that the fastening portion arranged in the groove can be displaced along the longitudinal extent of the groove in order to be pushed onto the fastening element to produce a non-positive connection or self-locking. The “longitudinal extension” of the groove is the main direction along which the groove extends, i.e., the direction along the longitudinal axis of the respective groove. According to the invention, it has been found that the wedge-shaped section preferably has an angle of inclination to the longitudinal extension of about 5°, for example an angle of inclination in the range of 2° to 8°, more preferably in the range of 3° to 7° and particularly preferably 5°. At such an angle of inclination, the wedge-shaped section can be pushed onto a fastening element particularly easily and at the same time can produce a particularly secure frictional connection.

According to a particularly preferred embodiment, the fastening elements are wedge-shaped. With such a wedge-shaped fastening element, the fastening element and a fastening portion can be pushed onto one another in order to produce a non-positive connection or self-locking effect. It is expedient for the wedge-shaped fastening elements to widen in each case along the longitudinal extension of the groove. In particular, this also has the advantage that the fastening element and the fastening portion can be pushed onto one another by displacement along the longitudinal extension of the groove to produce a non-positive connection or self-locking effect.

Preferably, such wedge-shaped fastening elements have an angle of inclination in the range of 2° to 8°.

According to a preferred embodiment, the fastening portions are each designed in the form of a bung, which can each be inserted into one of the grooves. Preferably, the fastening portions are also each designed in such a way that they can be displaced in one of the grooves. In particular, this has the advantage that they can each be pushed onto a fastening element to produce the non-positive connection by displacement in the respective groove—as described further below.

According to a particularly preferred embodiment, the fastening portions have a wedge-shaped section as above and the fastening elements are wedge-shaped as above. This has the particular advantage that it is especially easy to produce a secure non-positive connection of the fastening elements in the groove. Expediently, the wedge-shaped section of the fastening portions and the wedge-shaped fastening elements each widen in opposite directions along the longitudinal extension of the groove. Obviously, the wedge-shaped section of a fastening portion and the wedge-shaped fastening element can be pushed onto each other particularly easily and effectively, creating a self-locking effect.

In principle, the fastening elements can be made of any material. According to the invention, it has been found that the fastening elements are preferably formed from a material of low brittleness. Preferably, the fastening elements are formed from a tough material, for example from at least one of the following materials: Wood, plastic or metal. A particular advantage of fastening elements made of such a tough material lies in particular in their plastic deformability, on the basis of which a particularly strong and durable frictional connection can be produced. Preferably, the fastening elements are made of at least one of the materials plastic or metal, and very preferably of metal. According to the invention, it has been found that in particular by means of fastening elements made of at least one of the materials plastic or metal, a secure and force-fit fastening of the refractory bricks can be produced particularly easily. According to a preferred embodiment, the fastening elements are designed as a composite material of plastic and metal. Insofar as the fastening element is made of metal, this can in particular be made of steel.

According to a preferred embodiment, the grooves are each designed with an undercut, i.e., they have a recess in relation to the groove opening. Such an undercut has the particular advantage that, after the non-positive connection according to the invention has been made, a positive connection can also be made. This has the particular advantage of additionally securing the refractory bricks to the wall element, whereby the refractory bricks can be fastened particularly securely to the wall element.

According to a particularly preferred embodiment, the grooves are each designed as dovetail grooves. The grooves thus each have a cross-sectional area in the form of a dovetail. The cross-sectional area of the groove is herein considered to be the cross-sectional area of the groove perpendicular to the longitudinal extent of the groove. Such a dovetail-shaped cross-sectional area of a groove is known from structural engineering, particularly in the case of dovetail sheet piling.

According to the invention, it has been found that refractory bricks can be fastened particularly securely to the wall element if the grooves are each designed as dovetail grooves, because, as previously explained, in this case a positive connection can additionally be produced when the non-positive connection according to the invention is made, so that the refractory bricks can be fastened particularly securely to the wall element.

According to a further development of the idea of the invention, the fastening of the refractory bricks in this case can be in the form of dovetail sheet piling, whereby in each case a fastening portion together with a fastening element can form a dovetail sheet pile, which is fastened in a non-positive and positive (form-fitting) manner in the groove formed as a dovetail groove.

Insofar as the grooves are designed with an undercut, in particular in the form of a dovetail groove, the fastening sections can engage behind the undercut in each case in order, as explained above, to produce a positive connection in addition to the non-positive connection.

Preferably, the wall element is made of metal, preferably steel or copper. Particularly preferably, the wall element is formed in one piece.

According to one embodiment, a wall element, in particular made of metal, has pipes for the passage of liquid, in particular water, through the wall element. Such an embodiment is particularly suitable if the wall element is designed as a cooling element for cooling the refractory bricks.

According to one embodiment, the grooves are made of metal. Such an embodiment can obviously be present in particular if the wall element is made of metal, as explained above.

Preferably, the grooves extend along the entire surface of the wall element, i.e., along the entire length of the wall element. This has the particular advantage that the refractory bricks can be arranged and fastened along the entire length of the wall element.

Preferably, the grooves each have the same distance from one another.

According to one embodiment, it may be provided that the grooves are each of identical design, i.e., in particular also have an identical cross-sectional area.

Such uniform spacing and identical design of the grooves have the particular advantage that all refractory bricks can have the same dimensions in order to be attached to the wall element.

Preferably, the surface of the wall element along which the grooves run is flat. This enables particularly simple and uniform attachment of the refractory bricks to the wall element.

According to a preferred embodiment, the refractory bricks form a closed brickwork, in particular opposite the combustion chamber. In such a closed brickwork, adjacent bricks are in particular directly adjacent to each other. This has the particular advantage that penetration of components from the combustion chamber into the brickwork, for example hot combustion gases or molten metal, can be prevented. In particular, this can also prevent components from the combustion chamber from reaching the wall element and, in particular, any metallic components of the wall during furnace operation. This is because, as is known, the metallic components of a wall have a lower refractoriness than the refractory bricks. Since the wall according to the invention prevents such contact between components of the combustion chamber with such metallic components of the wall, the wall according to the invention proves to be particularly durable and corrosion-resistant to components from the combustion chamber.

It is also an object of the invention to provide a refractory brick for a wall for a furnace. Preferably, the refractory bricks of the wall according to the invention may each be formed according to the refractory brick according to the invention, as set forth below.

According to the invention, the refractory brick for a wall for a furnace comprises a surface and a fastening portion designed to be fastened in a groove of the wall, protruding from the surface, extending along a main direction, and having a wedge-shaped section widening along the main direction.

Particularly preferably, fastening portion as disclosed herein is designed to be non-positively fastened in a groove of the wall

The particular advantage of such a refractory brick lies especially in the fact that it can be fastened particularly easily and securely in a groove, especially in a groove of a wall element of a furnace according to the invention.

The refractory brick may preferably have a substantially cuboidal shape. One of the six side surfaces of such a cuboid-shaped brick may present a surface from which the attachment portion protrudes. This fastening portion may be formed as set forth above.

The fastening portion runs along a main direction, i.e., along a longitudinal extension. Preferably, the fastening portion runs along a main direction that is parallel to two opposite side edges of the surface.

As stated above, the fastening portion preferably has a wedge-shaped section. Preferably, this wedge-shaped section widens along the main direction of the fastening portion. As explained above, this has the particular advantage that such a wedge-shaped fastening section widens along the longitudinal extension of the groove when the fastening portion is arranged in the groove, as a result of which the fastening portion can be fastened in the groove particularly easily and securely with a non-positive connection.

According to a preferred embodiment, it is provided that the wedge-shaped section widens only on one side of the fastening portion along the main direction of the fastening portion. In particular, this also has the advantage that the fastening portion can run along the main direction of the fastening portion on its other side without changing its width, which makes it particularly easy to arrange and fasten the fastening portion in a groove. In particular, for fastening the fastening portion in a groove in this case, it may be sufficient, for example, to clamp a fastening element only on the widening side of the fastening element between the fastening element and the groove, as also disclosed in more detail in the following embodiments.

Preferably, it can be provided that the fastening portion is designed in such a way that it is aligned for fastening in a groove with its main direction along the longitudinal extension of the groove. This enables particularly simple and secure fastening of the brick in the groove, since the main direction of the fastening portion and the groove are aligned with each other along the same direction.

According to one embodiment, the fastening portion is designed to engage behind an undercut of a dovetail-shaped groove. As explained above, this enables particularly secure fastening of the fastening portion in the groove by forming dovetail sheet piling.

The refractory bricks according to the invention are preferably in the form of refractory ceramic bricks, i.e., refractory bricks consisting of a ceramic material. Particularly preferably, the refractory bricks consist of a sintered ceramic material, in particular a sintered ceramic material based on refractory oxide materials.

It is also an object of the invention to provide a fastening system comprising a refractory brick according to the invention and a fastening element as disclosed herein. As disclosed herein, such a fastening system enables a particularly secure and simple production of a non-positive fastening of the refractory brick in a groove.

As disclosed herein, the fastening portion of the refractory brick and the fastening element are designed in such a way that the fastening element can be clamped between the fastening portion, in particular the wedge-shaped section of the fastening element, and the groove in such a way that the refractory brick can be fastened, in particular non-positively, in a groove. In this respect, the fastening element can preferably be arranged on the fastening portion or is arranged on the latter in order to enable, in particular, non-positive fastening in a groove.

According to a particularly preferred embodiment, the fastening element, as disclosed herein, is wedge-shaped. The fastening element can preferably be arranged on the fastening portion or is arranged thereon in such a way that the wedge-shaped section of the fastening portion and the wedge-shaped fastening element widen in opposite directions.

The fastening element may be formed of any material in principle, but preferably of metal as disclosed herein.

It is also an object of the invention to provide a method of fastening a refractory brick in a groove, comprising the following steps:
providing a groove;
providing a refractory brick comprising a fastening portion disposable in the groove;
providing a fastening element clampable between the fastening portion and the groove in which the fastening portion is disposable;
disposing of the fastening portion in the groove;
non-positively fastening of the refractory brick in the groove by clamping the fastening element between the fastening section and the groove.

The refractory brick, the fastening element and the groove may be formed as disclosed herein. The placement of the fastening element between the fastening portion and the groove and the non-positive connection, respectively, may be performed as disclosed herein.

According to the invention, a “wall” for a furnace is understood to be not only a side wall of a furnace, but all components of a furnace that enclose the combustion chamber, i.e., the side walls, the furnace floor or the furnace ceiling. Particularly preferably, the wall according to the invention forms the furnace ceiling of a furnace.

It is also an object of the invention to provide a furnace which comprises at least one wall according to the invention. In particular, the furnace according to the invention is an industrial furnace. In principle, the furnace according to the invention can be in the form of any furnace, for example in the form of a firing furnace, heat treatment furnace, calcining furnace or metallurgical furnace. According to a particularly preferred embodiment, the wall according to the invention is intended for a metallurgical furnace or the furnace according to the invention is in the form of a metallurgical furnace. Such a metallurgical furnace may in particular be designed to receive a molten metal. In this case, the wall element may, as explained above, be present in particular as a coolable wall element, i.e., have conduits for the passage of cooling liquid.

It is also an object of the invention to provide a method of manufacturing a wall for a furnace according to the invention, comprising the following steps:
providing a wall element comprising a surface and a plurality of grooves extending along the surface, spaced apart and parallel to each other;
providing refractory bricks, each comprising a fastening portion disposable in one of the grooves;
providing fastening elements each clampable between one of the fastening portions and the groove in which the respective fastening portion is disposable;
disposing the respective fastening portions in one of the grooves in each case;
non-positively fastening the refractory bricks in the grooves by respectively clamping at least one of the fastening elements between the fastening portion of the respective refractory brick and the groove in which the respective fastening portion is disposed.

The wall, the wall element, the refractory bricks and the fastening elements can be designed as described above.

As explained above, when carrying out the method according to the invention, the respective fastening portion of a refractory brick can be arranged in a groove and then the fastening portion can be non-positively fastened in the groove by clamping at least one of the fastening elements between the fastening portion and the groove. Particularly preferably, as explained above, the fastening element and the fastening portion are pushed onto one another in the groove for clamping or for producing the non-positive fastening until a non-positive connection is produced. For this purpose, for example, the fastening element and the fastening portion can first be disposed at a distance from one another in the groove and then pushed onto one another until a non-positive connection is produced. Insofar as the fastening portion has a wedge-shaped section, as detailed above, and/or the fastening element is wedge-shaped, as detailed above, the wedge-shaped fastening section and the wedge-shaped fastening element can, for example, be pushed onto one another until they are fastened in the groove with self-locking or non-positive engagement.

All refractory bricks of the wall according to the invention can be fastened successively in the grooves until the wall according to the invention is completed. As described above, the refractory bricks can preferably be fastened successively to the wall element until they form a closed wall.

Further features of the invention are apparent from the claims, the figures and the accompanying figure description.

All of the features of the invention, individually or in combination, may be combined in any manner.

With reference to the following figures, an embodiment of the invention is explained in more detail.

Thereby shows

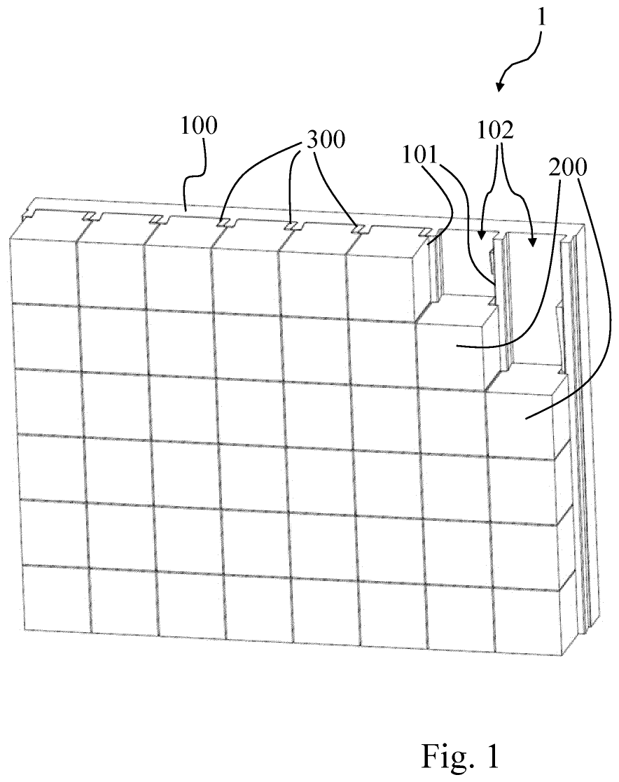

FIG. 1 an embodiment of a wall according to the invention in a perspective view from above;

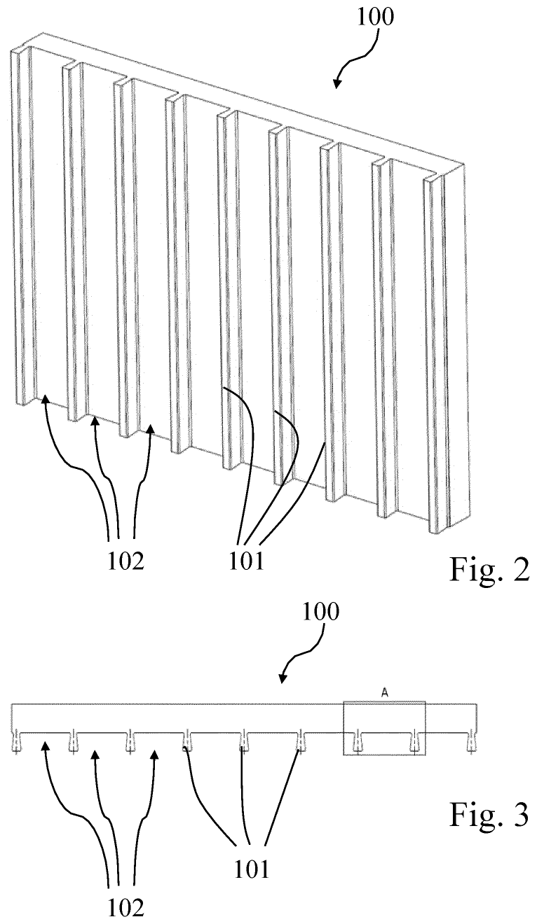

FIG. 2 a perspective view from above of a wall element of the wall according to FIG. 1;

FIG. 3 shows the wall element according to FIG. 2 in a view from above;

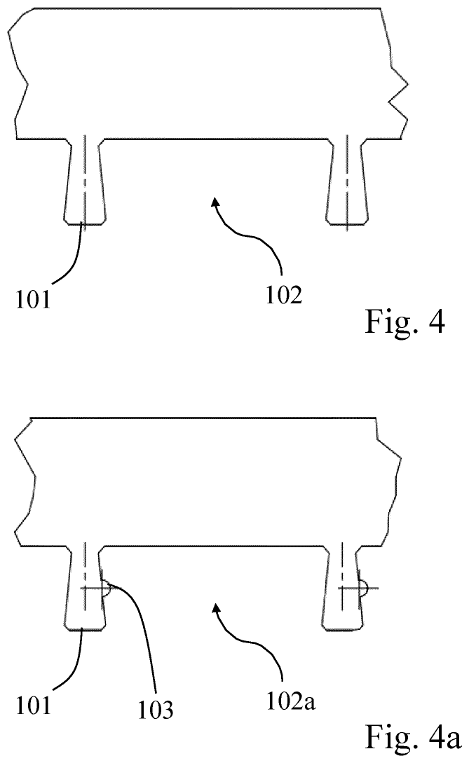

FIG. 4 an enlarged view of area A according to FIG. 3;

FIG. 4 a section of an alternative embodiment of a wall element in a top view;

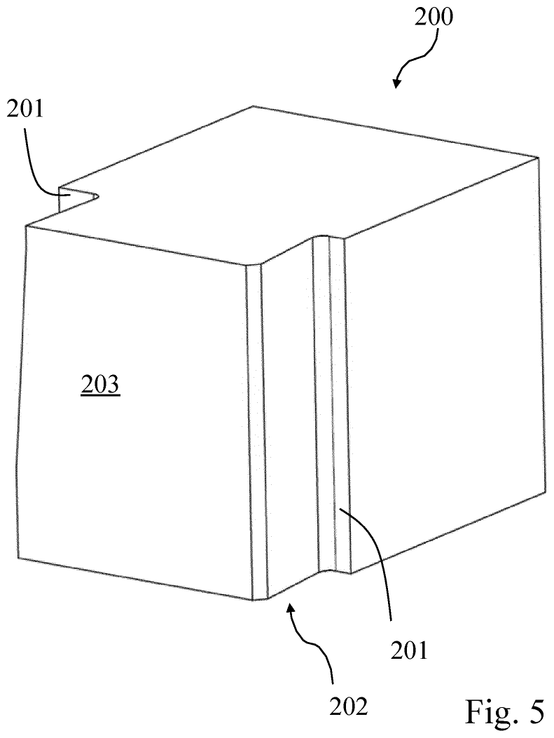

FIG. 5 a refractory brick of the wall according to FIG. 1 in a perspective view from oblique above;

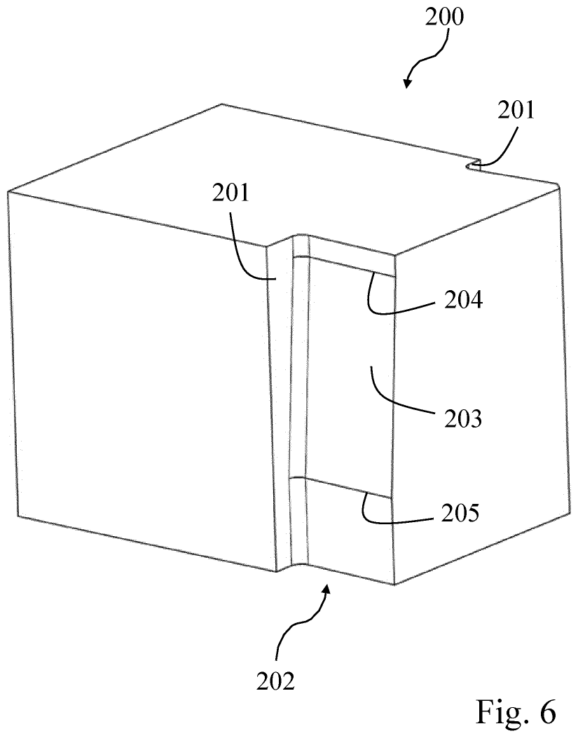

FIG. 6 the brick according to FIG. 5 in a perspective view from above at an angle from another perspective;

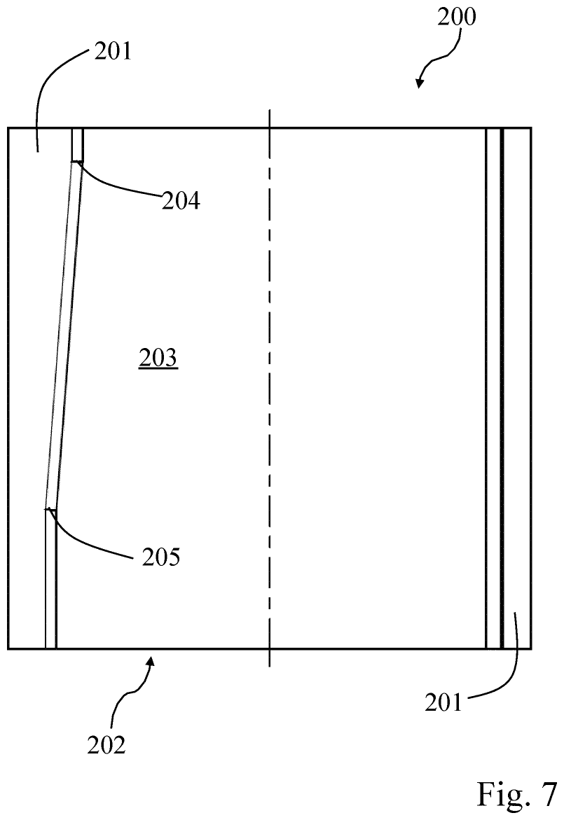

FIG. 7 the brick according to FIG. 5 in a frontal view of an attachment portion of the refractory brick;

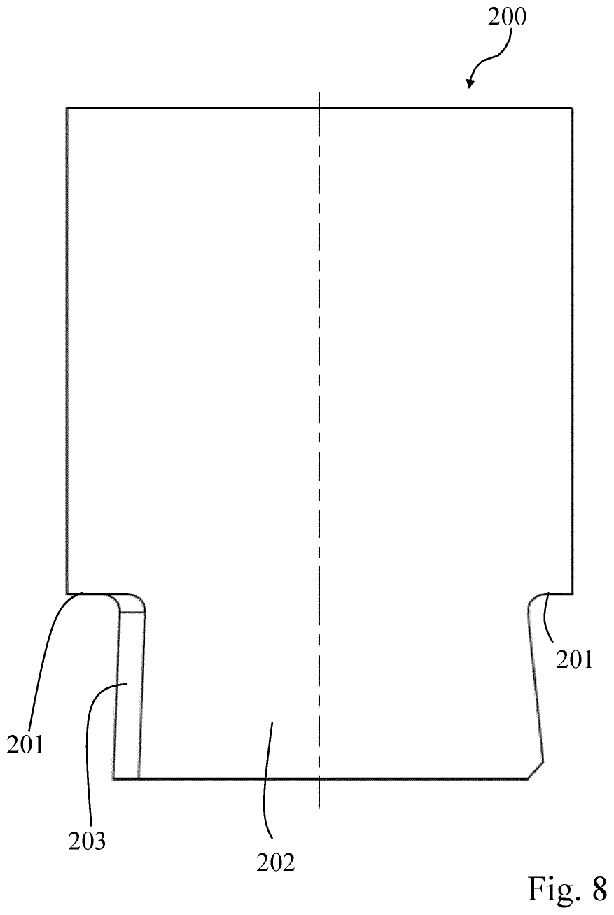

FIG. 8 the brick according to FIG. 5 in a frontal view from above;

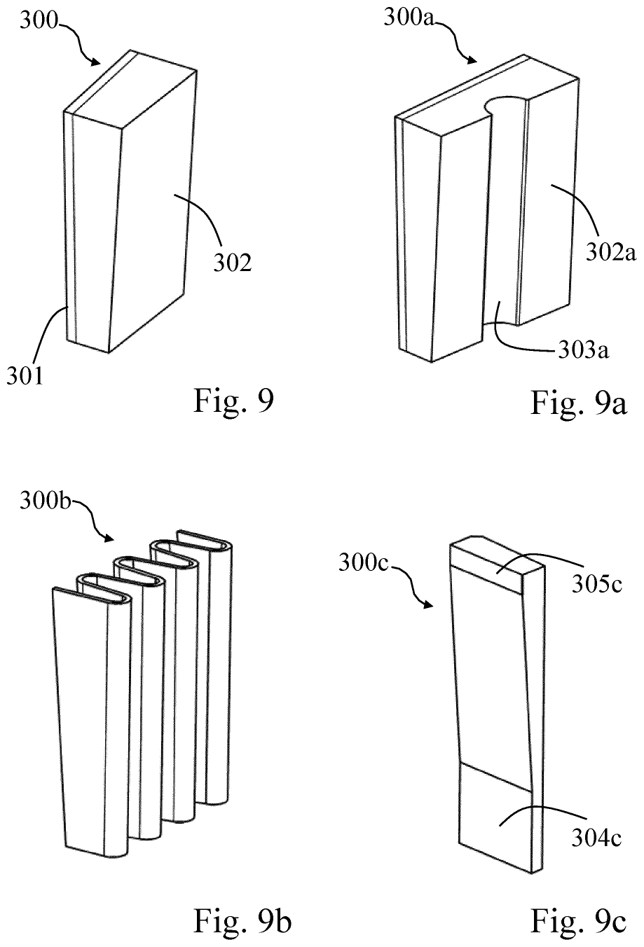

FIG. 9 a fastening element of the wall according to FIG. 1 in a perspective view from above;

FIG. 9a a perspective view from above of an alternative embodiment of a fastening element;

FIG. 9b another alternative embodiment of a fastening element in a perspective view from above;

FIG. 9c another alternative embodiment of a fastening element in a perspective view from above;

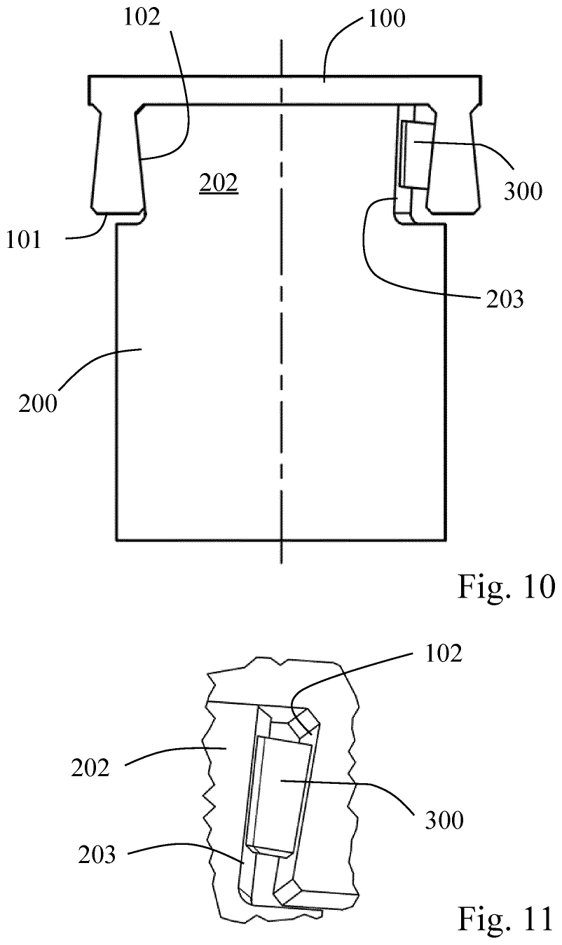

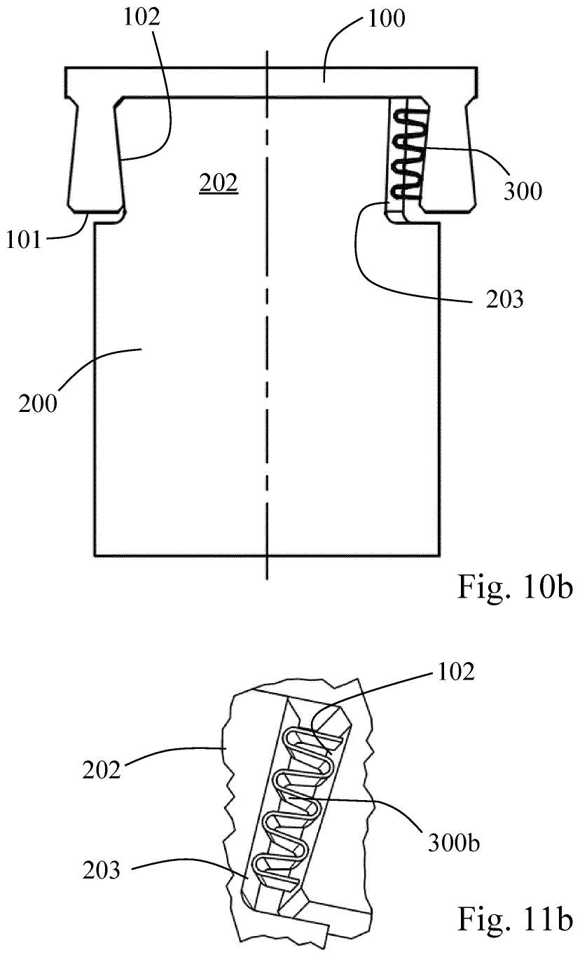

FIG. 10 a section of the wall according to FIG. 1 in a view from above;

FIG. 10b a section of an alternative embodiment of a wall in a top view;

FIG. 11 a section of the wall according to FIG. 1 in the area of a fastening element in a view from above; and

FIG. 11b a section of an alternative embodiment of a wall in the area of a fastening element in a top view.

In its entirety, the wall in FIG. 1 is marked with the reference sign 1.

The wall 1 comprises a wall element 100, refractory bricks 200 and fastening elements 300, of which only a few can be seen in FIG. 1, since the other fastening elements 300 are concealed by the refractory bricks 200.

The wall element 1 has a substantially panel-shaped form with a rectangular outer contour. On a flat surface 101 of the wall element 100, which faces the viewer in the view according to FIG. 1, a total of eight grooves 102 run at regular intervals and parallel to one another.

The wall element 100 is formed in one piece from copper.

The grooves 102 extend along the entire length of the surface 101, i.e., in the view according to FIG. 1, from the lower edge to the opposite upper edge of the wall element 100.

Six refractory bricks 200 are stacked in each of the eight grooves 102.

Each refractory brick 200 is formed as follows: The refractory brick 200 comprises a sintered ceramic material based on the oxides MgO and Al₂O₃. The refractory brick 200 has a substantially cuboid shape. One of the six side surfaces of the refractory brick forms a surface 201 from which a fastening portion 202 protrudes. The fastening portion 202 extends along a main direction, from top to bottom in the illustration according to FIGS. 1, 5, 6 and 7. In this regard, the fastening portion 202 extends from one side edge of the surface 201 (the upper side edge in FIGS. 5, 6, and 7) to the opposite side edge of the surface 201 (the lower side edge in FIGS. 5, 6, and 7). The fastening portion 202 has a wedge-shaped section 203 that widens along the main direction of the fastening portion (from top to bottom in the illustration according to FIGS. 1, 5 and 6). When the fastening portion 202 is disposed in one of the grooves 102, the wedge-shaped section 203 correspondingly widens along the longitudinal extension of the groove 102, as further detailed below. The wedge-shaped section 203 extends from a first bend edge 204 to a second bend edge 205 of the fastening portion 202, and the angle of inclination of the wedge-shaped section 203 with respect to the main direction of the fastening portion 202 is 5°. The fastening portion 202 widens away from the surface 201, so that the fastening portion 202 has an overall approximately dovetail-shaped cross-sectional area. The fastening portion 202 is formed in the manner of a bung and is dimensioned to be disposed in one of the grooves 102 and to be slidable in the groove 102 along the longitudinal extension of the groove 102.

Each of the fastening elements 300 is formed as follows: The fastening element 300 is formed as a composite material comprising a plastic plate 301 and a steel block 302 bonded thereto. The plastic plate 301 is formed as a panel-shaped plate having a rectangular outer contour. Flush with the outer edges of the plastic plate 301, the steel block 302 is bonded thereto. The steel block 302 is wedge-shaped with an angle of inclination of about 5°. Overall, the fastening element 300 thus has a wedge shape.

The refractory bricks 200 are disposed with their respective fastening portion 202 in the grooves 102 of the wall 1, wherein the wedge-shaped section 203 of the respective fastening sections 202 is disposed in the respective groove 102 in such a way that it widens along the longitudinal extension of the groove 102. In the exemplary embodiment according to FIG. 1, the fastening portions 202 are each disposed in one of the grooves 102 such that the respective wedge-shaped section 203 widens from top to bottom along the longitudinal extension of the respective groove 102. Furthermore, in the exemplary embodiment according to FIG. 1, the wedge-shaped fastening elements 300 are each disposed in one of the grooves 102 in such a way that they widen along the longitudinal extension of a groove 102, in the exemplary embodiment according to FIG. 1 along the direction from bottom to top, i.e., opposite to the direction along which the wedge-shaped section 203 of the refractory bricks 200 widens.

The grooves 102 are each formed as dovetail grooves, i.e., each has a substantially dovetail-shaped cross-sectional area, as can be seen particularly well in FIG. 4.

For fastening the refractory bricks 200 in one of the grooves 102, a fastening element 300 is clamped in each case between the respective fastening portion 202 of a refractory brick 200 and the groove 102 in which the respective fastening portion 202 is arranged in such a way that the respective refractory brick 200 is fastened in a non-positive manner in the respective groove 102 by this clamping. Accordingly, all refractory bricks 200 of the wall 1 are non-positively fastened in one of the respective grooves 102.

Due to the dovetail-shaped cross-sectional area of the grooves 102 and the dovetail-shaped cross-sectional area of the fastening portions 202, the latter are also positively engaged in the grooves 102 after the non-positive connection has been made. As a result, the refractory bricks 200 are particularly securely fastened in the grooves 102.

The refractory bricks 200 are dimensioned in such a way that they form a closed masonry, as this is illustrated in particular in FIG. 1. In this closed masonry, the side faces of adjacent refractory bricks 200 each lie directly against each other over their entire surface, so that the wall 1 forms a closed masonry opposite the combustion chamber. As a result, components in the combustion chamber of the furnace, which is bounded by the wall 1, come into contact exclusively with the refractory bricks 200 of the wall 1, so that the wall 1 represents a highly refractory resistance to components in the combustion chamber. In particular, such a closed masonry wall can prevent components in the combustion chamber of the furnace from coming into contact with metallic components of the wall 1.

The wall 1 shown in the embodiment serves to delimit a combustion chamber of a metallurgical furnace for receiving a molten metal, thereby forming the ceiling of the furnace. The closed masonry forms a highly refractory resistance to the molten metal. In particular, the molten metal does not come into contact with any metallic components of the wall 1.

To make the wall 1, the wall element 100, the refractory bricks 200 and the fasteners 300 were first provided.

Next, each refractory brick 200 was attached to the wall member 100 as follows: First, a fastening member 300 and the fastening portion 202 were spaced apart from each other in a groove 102. In this process, the widening direction of the wedge-shaped section 203 and the wedge-shaped fastening element 300 were oriented in opposite directions so that the wedge-shaped section 203 and the fastening element 300 could be slid onto each other when they were slid onto each other. Next, the refractory brick 200 was pushed toward the fastening element 300 so that the fastening portion 203 of the refractory brick 200 was pushed onto the fastening element 300. This sliding on was continued until the fastening element 300 was clamped or squeezed between the fastening section 203 and the groove 102 in such a way that the refractory brick 200 was non-positively or self-lockingly fastened in the groove 102 via the fastening portion 202. The fastening element 300 clamped between the fastening portion 203 and the groove 102 can be seen well in FIG. 11.

Accordingly, each refractory brick 200 was successively arranged in one of the grooves 102. In the exemplary embodiment according to FIG. 1, the refractory bricks 200 were each fastened in a groove 102 from top to bottom.

FIG. 4a shows an alternative embodiment of a groove 102a. In this groove 102a, one of the two side walls of the groove 102a has a hump-shaped protrusion 103. This hump-shaped protrusion 103 cooperates with an alternative embodiment of a fastening element 300a shown in FIG. 9a. The fastening element 300a is substantially the same as the fastening element 300, except that the metal block 302a has a groove-like recess 303a into which the hump-like projection 103 is inserted when the fastening element 300a is clamped between a fastening portion 203 and the groove 102a. Through this, the fastening element 300a is additionally secured in position.

FIG. 9c shows another alternative embodiment of a fastening element 300c. The fastening element 300c again has a substantially wedge shape, but with respective end portions 304c, 305c that are not wedge-shaped.

Another alternative embodiment of a fastening element 300b is shown in FIG. 9b. The fastening element 300b is formed of corrugated folded metal sheet in a wedge shape. The fastening element 300b is shown in clamping position between the fastening portion 203 and the groove 102 in FIGS. 10b and 11b.

1. Wall (1) for a furnace, comprising:
1. a wall element (100) comprising
1.1 a surface (101) and
1.2 a plurality of grooves (102),
1.2.1 extending along the surface (101),
1.2.2 spaced apart and
1.2.3 parallel to each other;
2. refractory bricks (200), each comprising.
2.1 a fastening portion (202) which is
2.1.1 disposed in one of the grooves (102);
3 fastening elements (300), each
3.1 clamped between one of the fastening portions (202) and the groove (102) in which the respective fastening portion (202) is disposed; wherein
4. the refractory bricks (200) are each non-positively fastened in the groove (102) by clamping at least one of the fastening elements (300) between the fastening portion (202) of the respective refractory brick (200) and the groove (102) in which the respective fastening portion (202) is disposed.

2. Wall (1) according to claim 1, wherein the fastening portions (202) each comprise a wedge-shaped section (203) and wherein at least one of the fastening elements (300) is clamped between the wedge-shaped section (203) and the groove (102) in each case.

3. Wall (1) according to claim 2, wherein the wedge-shaped section (203) widens along a longitudinal extension of the groove (102).

4. Wall (1) according to claim 1, wherein the fastening elements (300) are wedge-shaped.

5. Wall (1) according to claim 4, wherein the wedge-shaped fastening elements (300) widen along a longitudinal extension of the groove (102).

6. Wall (1) according to claim 2, wherein the wedge-shaped section (203) of the fastening portions (202) and the wedge-shaped fastening elements (300) respectively widen in opposite directions along a longitudinal extension of the groove (102).

7. Wall (1) according to claim 1, wherein the fastening elements (300) are formed of metal.

8. Wall (1) according to claim 1, wherein the grooves (102) are formed with undercut.

9. Wall (1) according to claim 1, wherein the grooves (102) are each formed as a dovetail groove.

10. Wall (1) according to claim 8, wherein the fastening sections (202) each engage behind the undercut.

11. Wall (1) according to claim 1, wherein the wall element (100) is formed of metal.

12. Refractory brick (200) for a wall (1) for a furnace, comprising:
12.1 a surface (201); and
12.2 a fastening portion (202) that is
12.2.1 is designed to be fastened in a groove (102) of the wall (1),
12.2.2 protruding from the surface (201),
12.2.3 extending along a main direction, and
12.2.4 having a wedge-shaped section (203) widening along the main direction.

13. Furnace comprising a wall (1) according to claim 1.

14. Method of manufacturing a wall (1) for a furnace according to claim 1, comprising the following steps:
A. providing of a wall element (100), comprising
A.1 a surface (101) and
A.2 a plurality of grooves (102),
A.2.1 extending along the surface (101),
A.2.2 spaced apart, and
A.2.3 parallel to each other;
B. providing of refractory bricks (200), each comprising
B.1 a fastening portion (202)
B.1.1 disposable in one of the grooves (102);
C. providing fastening elements (300), each
C.1 clampable between one of the fastening portions (202) and the groove (102) in which the respective fastening portion (202) is disposable;
D. disposing the respective fastening portions (202) in one of the grooves (102), respectively;
E. non-positively fastening the refractory bricks (200) in the grooves (102) by respectively clamping at least one of the fastening elements (300) between the fastening portion (202) of the respective refractory brick (200) and the groove (102) in which the respective fastening portion (202) is disposed.

15. The method of claim 14, wherein for clamping the respective fastening element (300) between the fastening portion (202) of the respective refractory brick (200) and the groove (102), the respective fastening portion (202) and the respective fastening element (300) are pushed onto each other.

16. The refractory brick (200) of claim 12, wherein the fastening portion (202) is configured to engage behind an undercut of a dovetail-shaped groove (102).

17. A fastening system comprising a refractory brick (200) according to claim 12 and a fastening element (300), wherein the fastening portion (202) of the refractory brick (200) and the fastening element (300) are formed such that the fastening element (300) is clampable between the fastening portion (202) and the groove (102) such that the refractory brick (200) is fastenable in the groove (102).

18. Fastening system according to claim 17, wherein the fastening element (300) is wedge-shaped.

19. Fastening system of claim 18, wherein the wedge-shaped section (203) and the wedge-shaped fastening element (300) widen in opposite directions.

20. Fastening system according to claim 17, wherein the fastening element (300) is formed of metal.

21. A method of fastening a refractory brick (200) in a groove (102), comprising the following steps:
A. providing of a groove (102);
B. providing a refractory brick (200) comprising a fastening portion (202) disposable in the groove (102);
C. providing a fastening element (300) clampable between the fastening portion (202) and the groove (102) in which the fastening portion (202) is disposable;
D. disposing the fastening portion (202) in the groove (102);
E. non-positively fastening the refractory brick (200) in the groove (102) by clamping the fastening element (300) between the fastening portion (202) and the groove (102).
